(19) United States
(12) Patent Application Publication
(10) Pub. No.: US 2016/0147117 A1
(43) Pub. Date: May 26, 2016

(54) PIXEL STRUCTURES FOR LIQUID CRYSTAL DISPLAY DEVICE

(71) Applicant: AU Optronics Corporation, Hsinchu (TW)

(72) Inventors: Kung-Ching Chu, Hsinchu (TW); Sung-Yu Su, Hsinchu (TW)

(21) Appl. No.: 14/551,794

(22) Filed: Nov. 24, 2014

(51) Int. Cl. G02F 1/1343

(52) U.S. Cl. CPC G02F 1/134309; G02F 1/13439; G02F 2001/134318

(57) ABSTRACT

In one aspect of the invention, a pixel structure comprises a substrate and a first electrode disposed on the substrate, a first dielectric layer disposed on the first electrode, and a second electrode disposed on the first dielectric layer. The second electrode comprises a pair of first electrode strips and a second electrode strip disposed between the pair of first electrode strips. Each first electrode strip has a width W1, and the second electrode strip has a width W2 that is different from the width W1 along a first direction. In one embodiment, the first electrode strip width W1 and the second electrode strip width W2 are constant along a second direction that is different from the first direction. In another embodiment, the first electrode strip width W1 and the second electrode strip width W2 are variable along the second direction.

### FIELD OF THE INVENTION

The present invention generally relates to a liquid crystal display (LCD) device, and more particularly to pixel structures with variable electrode widths.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the present invention.

The fringe field switching (FFS) technology is commonly used in a display device, such as a mobile device and a liquid crystal display panel, because of its feature of wide viewing angle and no color-shift. The latest FFS technology is trended in high resolution and the retina technology of high PPI. At present, the power consumption of the display device will affect the standby time. Thus, the standby time can be extended when the power consumption of the display device can be reduced to achieve energy saving. Lower operating frequency is a kind of method to reduce power consumption. However, for a conventional display device 10 shown in FIG. 5, where the pixel electrode strips 11, 12 and 13 have the same width, when it operates at a lower frequency, flickers occur, because the flexoelectric effect of liquid crystal molecules leads to a transmittance difference when the image is converted by a positive frame and a negative frame.

Therefore, a heretofore unaddressed need exists in the art to address the aforementioned deficiencies and inadequacies.

### SUMMARY OF THE INVENTION

The present invention, in one aspect, relates to a pixel structure. In one embodiment, the pixel structure comprises a substrate and a first electrode disposed on the substrate, a first dielectric layer disposed on the first electrode, and a second electrode disposed on the first dielectric layer. The second electrode comprises a pair of first electrode strips and a second electrode strip disposed between the pair of first electrode strips to define a first pitch S1 between one of the first electrode strips and the second electrode strip and a second pitch S2 between the second electrode strip and the other one of the first electrode strips. Each first electrode strips has a width W1, and the second electrode strip has a width W2 that is different from the width W1 along a first direction.

In one embodiment, the width W1 of each first electrode strip and the width W2 of the second electrode strip are constant along a second direction that is different from the first direction. A ratio of W1/W2 is in a range from about 0.2 to about 0.8, or in a range from about 2 to about 4.

In another embodiment, the width W1 of each first electrode strip and the width W2 of the second electrode strip are variable along the second direction.

In one embodiment, each first electrode strip has a first portion with a first width W1a and a second portion with a second width W1b, extending from the first portion along the second direction, and the second electrode strip has a first portion with a first width W2a and a second portion with a second width W2b, extending from the first portion along the second direction, where W1a>W2a and W1b<W2b, or W1a<W2a and W1b>W2b.

In one embodiment, a ratio of W1a/W1b is in a range from about 0.2 to about 0.8, and a ratio of W2a/W2b is in a range from about 2 to about 4. In another embodiment, the ratio of W1a/W1b is in a range from about 2 to about 4, and the ratio of W2a/W2b is in a range from about 0.2 to about 0.8.

In one embodiment, each first electrode strip has one or more first portions with a first width W1a and one or more second portions with a second width W1b, where the one or more first portions and the one or more second portions are alternatively located along the second direction. The second electrode strip has one or more first portions with a first width W2a and one or more second portions with a second width W2b, where the one or more first portions and the one or more second portions are alternatively located along the second direction, where W1a>W2a and W1b<W2b, or W1a<W2a and W1b>W2b.

In one embodiment, a ratio of W1a/W1b is in a range from about 0.2 to about 0.8, and a ratio of W2a/W2b is in a range from about 2 to about 4. In another embodiment, the ratio of W1a/W1b is in a range from about 2 to about 4, and the ratio of

W2a/W2b is in a range from about 0.2 to about 0.8.

In one embodiment, one of the first and second electrodes is a pixel electrode, and the other of the first and second electrodes is a common electrode.

Further the pixel structure comprises a second dielectric layer formed between the first electrode and the substrate.

In another aspect of the present invention, a pixel structure comprises a first electrode; a dielectric layer formed on the first electrode; and a second electrode formed on the dielectric layer. The second electrodes comprises one or more first electrode strips and one or more second electrode strips, where the one or more first electrode strips and the one or more second electrode strips are spaced-apart and alternatively arranged along a first direction. Each first electrode strip has a width W1 and each second electrode strip has a width W2 along the first direction. The width W1 and the width W2 are different from each other.

In one embodiment, the width W1 of each first electrode strip and the width W2 of each second electrode strip are constant along a second direction that is different from the first direction.

In another embodiment, the width W1 of each first electrode strip and the width W2 of each second electrode strip are variable along the second direction.

In one embodiment, each first electrode strip has a first portion with a first width W1a and a second portion with a second width W1b, extending from the first portion along the second direction, and each second electrode strip has a first portion with a first width W2a and a second portion with a second width W2b, extending from the first portion along the second direction, wherein W1a>W2a and W1b<W2b, or W1a<W2a and W1b>W2b.

In one embodiment, each first electrode strip has one or more first portions with a first width W1a and one or more second portions with a second width W1b, the one or more first portions and the one or more second portions being alternatively located along the second direction, and each second electrode strip has one or more first portions with a first width W2a and one or more second portions with a second width W2b, the one or more first portions and the one or more second portions being alternatively located along the second direction, wherein W1a>W2a and W1b<W2b, or W1a<W2a and W1b>W2b.

In one embodiment, one of the first and second electrodes is a pixel electrode, and the other of the first and second electrodes is a common electrode.

In yet another aspect of the present invention, a liquid crystal display comprises a display panel having a plurality of pixels. Each pixel comprises the pixel structure as disclosed above.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1A shows schematically a top view of a pixel structure according to one embodiment of the present invention.

FIG. 1B shows schematically a cross-sectional view along an A-A′ line of the pixel structure shown in FIG. 1A.

FIG. 2A shows schematically a top view of a pixel structure according to one embodiment of the present invention.

FIG. 2B shows schematically a cross-sectional view along an A-A′ line of the pixel structure shown in FIG. 2A.

FIG. 2C shows schematically a cross-sectional view along a B-B′ line of the pixel structure shown in FIG. 2A

FIG. 3A shows schematically a top view of a pixel structure according to one embodiment of the present invention.

FIG. 3B shows schematically a cross-sectional view along an A-A′ line of the pixel structure shown in FIG. 3A.

FIG. 3C shows schematically a cross-sectional view along a B-B′ line of the pixel structure shown in FIG. 3A

FIG. 4 shows schematically a top view of a pixel structure according to one embodiment of the present invention.

FIG. 5 shows schematically a top view of a pixel structure according to the prior art.

FIG. 6A shows schematically a voltage-dependent transmittance (V-T) curve for the pixel structure shown in FIG. 1A.

FIG. 6B shows schematically a V-T curve for the pixel structure shown in FIG. 2A.

FIG. 6C shows schematically a V-T curve for the pixel structure shown in FIG. 3A.

FIG. 6D shows schematically a V-T curve for the prior art pixel structure shown in FIG. 5.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top,” and “front” or “back” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

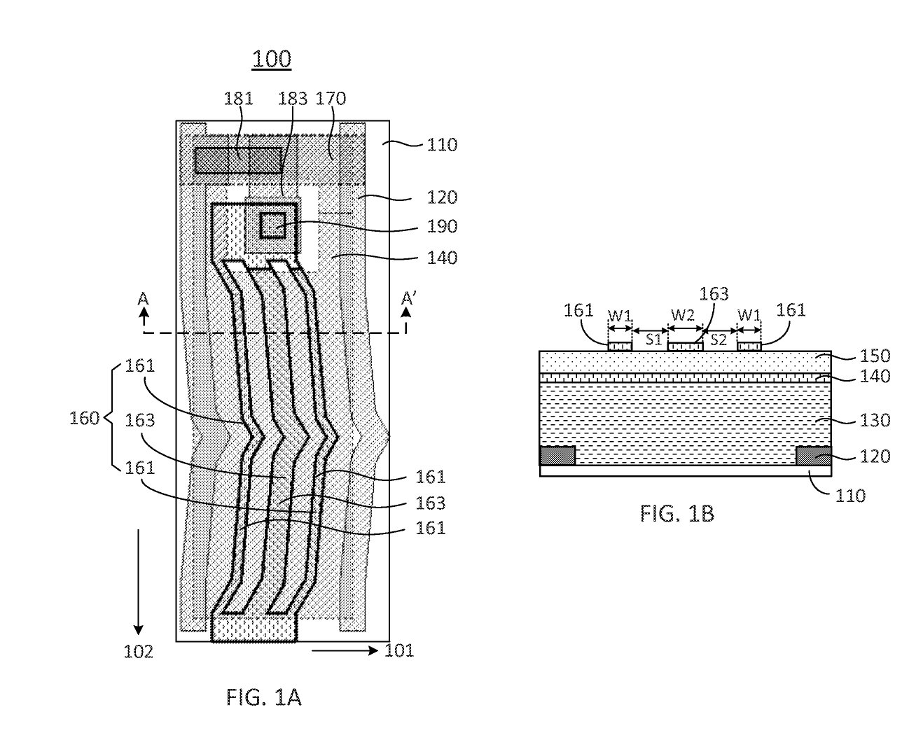

The description will be made as to the embodiments of the present invention in conjunction with the accompanying drawings in FIGS. 1-4 and 6. In accordance with the purposes of this invention, as embodied and broadly described herein, this invention, in one aspect, relates to a pixel structure utilizing fringe field switching (FFS) technology, by designing pixel structures with variable electrode widths.

FIGS. 1A and 1B show schematically a top view and a cross-sectional view of a pixel structure 100 according to one embodiment of the present invention, where FIG. 1A shows the top view of the pixel structure 100 and FIG. 1B shows the cross-sectional view of the pixel structure 100. According to the embodiment, a pixel structure 100 includes a substrate 110 and a first electrode 140 disposed on the substrate 110, a first dielectric layer 150 disposed on the first electrode 140, and a second electrode 160 disposed on the first dielectric layer 150. The second electrodes 160 comprises a pair of first electrode strips 161 and a second electrode strip 163 disposed between the pair of first electrode strips 161 to define a first pitch S1 between one of the first electrode strips 161 and the second electrode strip 163 and a second pitch S2 between the second electrode strip 163 and the other one of the first electrode strips 161. In one embodiment, the first pitch S1 and the second pitch S2 are the same. In another embodiment, the first pitch S1 and the second pitch S2 are different. As disclosed above are not intended to limit the scope of the present invention. Designers can design the first pitch S1 and the second pitch S2 depending on their demands. Such corresponding changes are also within the scope of the present invention.

According to the invention, each first electrode strips 161 has a width W1, and the second electrode strip 163 has a width W2 that is different from the width W1 along a first direction 101. In the exemplary embodiment shown in FIGS. 1A and 1B, the width W1 of the first electrode strip 161 and the width W2 of the second electrode strip 163 are constant along a second direction 102 that is different from the first direction 101, and W1<W2. The first direction 101 and the second direction 102 are intersected with each other. In certain embodiments, the first direction 101 may be along with a gate line 170, while the second direction 102 may be along with a data line 120.

In certain embodiments, each of the widths W1 and W2 is in a range from about 1 μm to about 4 μm.

In one embodiment, a ratio of W1/W2 is in a range from about 0.2 to about 0.8. In another embodiment, the ratio of W1/W2 is in a range from about 2 to about 4.

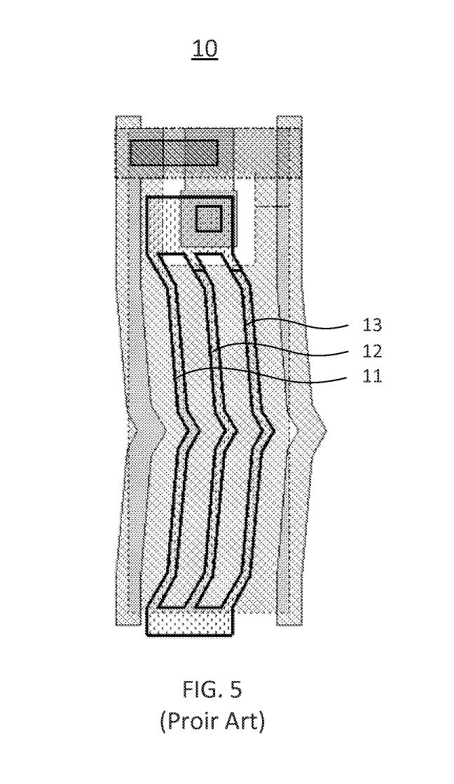

Compared with the prior art pixel structure as shown in FIG. 5, the flexoelectric effect (FEE) ratio of the pixel structure according to embodiments of the invention can be reduced significantly. Table 1 lists the FEE ratios of the pixel structure according to Embodiments I-VI of the invention and the prior art pixel structure. In Embodiments I, II and III, the ratio of W1/W2 is in a range from about 0.2 to about 0.8, while the ratio of W1/W2 is a range from about 2 to about 4 in Embodiments IV, V and VI. In all of Embodiments I-VI, the FEE ratios of the pixel structure are lower than that of the prior art pixel structure. If the width W1 or W2 is lower than 1 μm, which may practically have a difficulty in process, the FEE ratio thereof maybe increases. In addition, the FEE ratio may be decreased when the width W1 or W2 is wider than 4 μm, which may affect the liquid crystal efficiency or transmittance. According to the invention, the pixel structure having the ratio of W1/W2 being in a range from about 0.2 to about 0.8, or in a range from about 2 to about 4, decreases the FEE ratio with the better liquid crystal efficiency or transmittance.

TABLE 1
The FEE Ratios of Different Embodiments

| | W1 (μm) | W2 (μm) | W1/W2 | FEE ratio |
|---|---|---|---|---|
| Embodiment I | 1 | 4 | 0.25 | 11.21% |
| Embodiment II | 2 | 4 | 0.5 | 11% |
| Embodiment III | 3 | 4 | 0.75 | 10.73% |
| Prior art | 1 | 1 | 1 | 38.06% |
| Embodiment IV | 2 | 1 | 2 | 28.01% |
| Embodiment V | 3 | 1 | 3 | 18.79% |
| Embodiment VI | 4 | 1 | 4 | 10.96% |

In certain embodiments, one of the first and second electrodes 140 and 160 is a pixel electrode, and the other of the first and second electrodes 140 and 160 is a common electrode. In this exemplary embodiment as shown in FIGS. 1A and 1B, the second electrodes 160 is a pixel electrode, and the second electrodes 160 is electrically connecting to a drain electrode 183 through a contact hole 190.

In addition, the pixel structure 100 further comprises a second dielectric layer 130 formed between the first electrode 140 and the substrate 110. The pixel structure 100 is operably coupled to a data line 120 and a gate line 170.

In one aspect of the present invention, a liquid crystal display comprises a display panel having a plurality of pixels. Each pixel comprises the pixel structure as disclosed above. Accordingly, the FEE ratio is reduced significantly, resulting in better liquid crystal efficiency or transmittance.

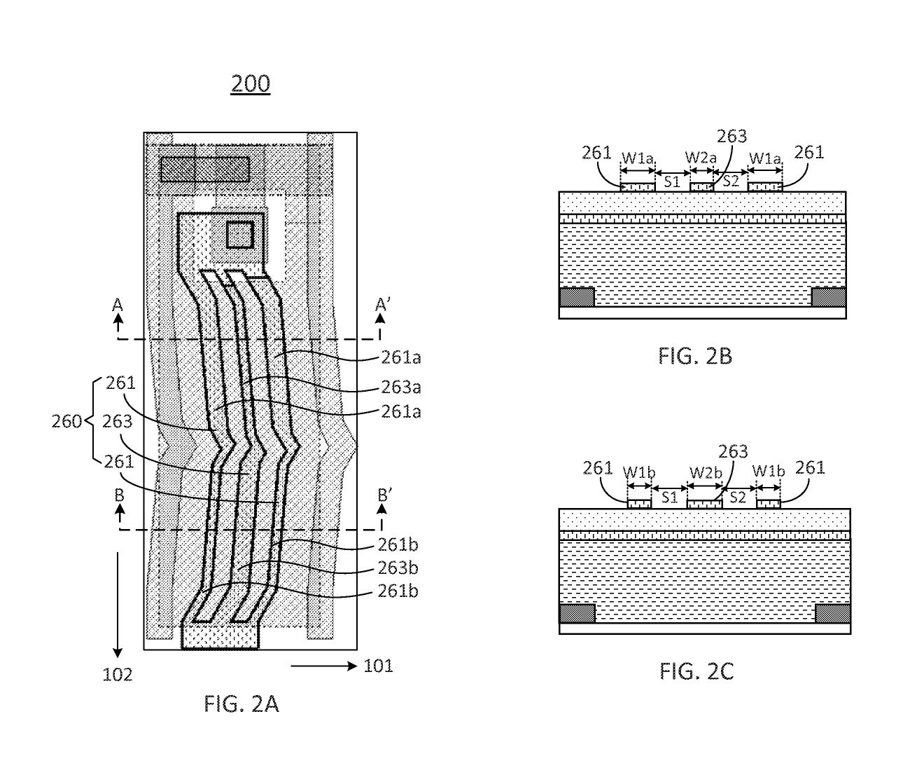

FIGS. 2A-2C show respectively a top view, a cross-sectional view along an A-A′ line and a cross-sectional view along a B-B′ line of a pixel structure 200 according to another embodiment of the invention. The pixel structure 200 is similar to the pixel structure 100, as shown in FIGS. 1A and 1B, except that the width W1 of each first electrode strip 261 and the width W2 of the second electrode strip 263 are variable along the second direction 102. According to the invention, the width W1 of each first electrode strip 261 further comprises the first width W1a and the second width W1b, and the width W2 of the second electrode strip 263 further comprises the first width W2a and the second width W2b. In certain embodiments, each first electrode strip 261 has a first portion 261a with a first width W1a and a second portion 261b with a second width W1b, extending from the first portion 261a along the second direction 102. The second electrode strip 263 has a first portion 263a with a first width W2a and a second portion 263b with a second width W2b, extending from the first portion 263a along the second direction 102. In this embodiment shown in FIGS. 2A-2C, W1a>W2a and W1b<W2b. In another embodiment, W1a<W2a and W1b>W2b.

In one embodiment, the ratio of W1a/W1b is in a range from about 0.2 to about 0.8, and a ratio of W2a/W2b is in a range from about 2 to about 4, when W1a<W2a and W1b>W2b. In another embodiment, the ratio of W1a/W1b is in a range from about 2 to about 4, and a ratio of W2a/W2b is in a range from about 0.2 to about 0.8, when W1a>W2a and W1b<W2b.

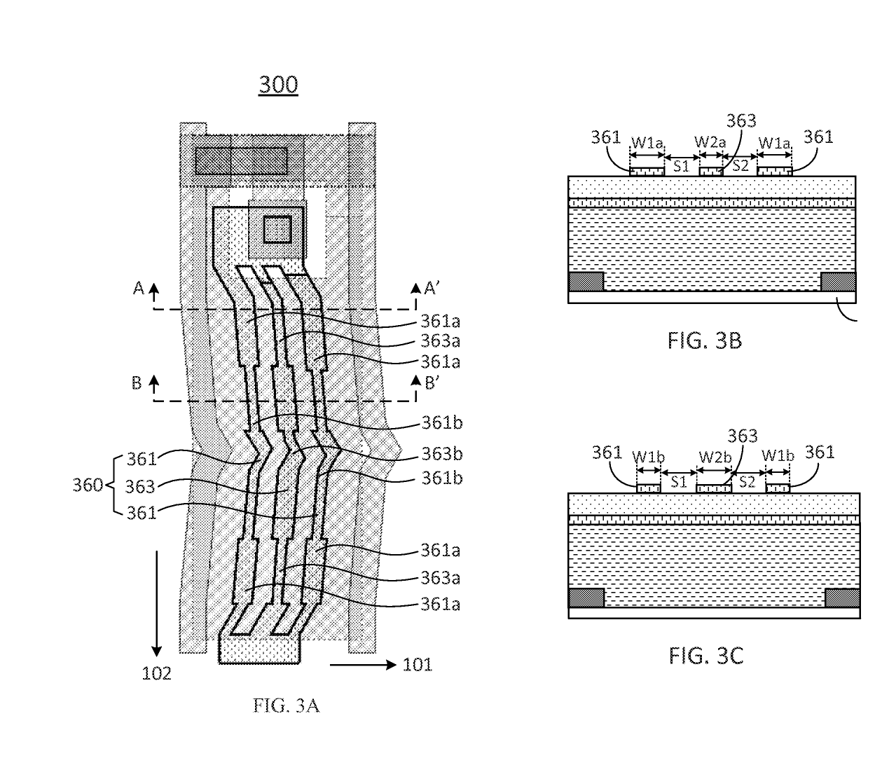

Referring to FIGS. 3A-3C, a top view, a cross-sectional view along an A-A′ line and a cross-sectional view along a B-B′ line of a pixel structure 300 are respectively shown according to yet another embodiment of the invention. The pixel structure 300 is similar to the pixel structure 200, as shown in FIGS. 2A-2C, except that each first electrode strip 361 has one or more first portions 361a with a first width W1a and one or more second portions 361b with a second width W1b, the one or more first portions 361a and the one or more second portions 363b being alternatively located along the second direction 102; and the second electrode strip 363 has one or more first portions 363a with a first width W2a and one or more second portions 363b with a second width W2b, the one or more first portions 363a and the one or more second portions 363b being alternatively located along the second direction 102. In this embodiment shown in FIGS. 3A-3C, W1a>W2a and W1b<W2b. In another embodiment, W1a<W2a and W1b>W2b.

In one embodiment, the ratio of W1a/W1b is in a range from about 0.2 to about 0.8, and a ratio of W2a/W2b is in a range from about 2 to about 4, when W1a<W2a and W1b>W2b. In another embodiment, the ratio of W1a/W1b is in a range from about 2 to about 4, and a ratio of W2a/W2b is in a range from about 0.2 to about 0.8, when W1a>W2a and W1b<W2b.

Similarly, for a liquid crystal display with the pixel structure 200 or 300, as disclosed above, the FEE ratio can also be reduced significantly, resulting in the better liquid crystal efficiency or transmittance.

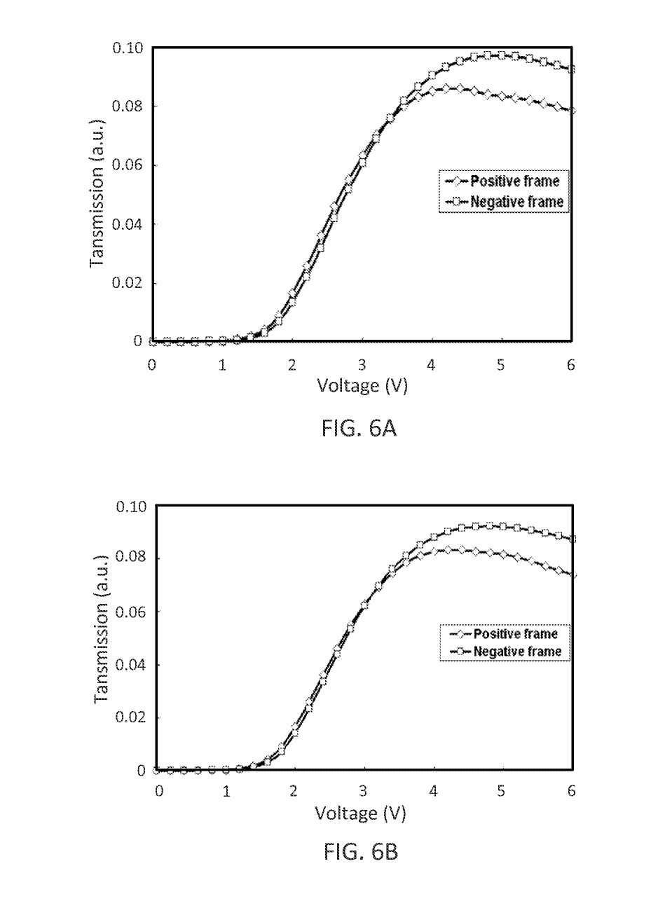

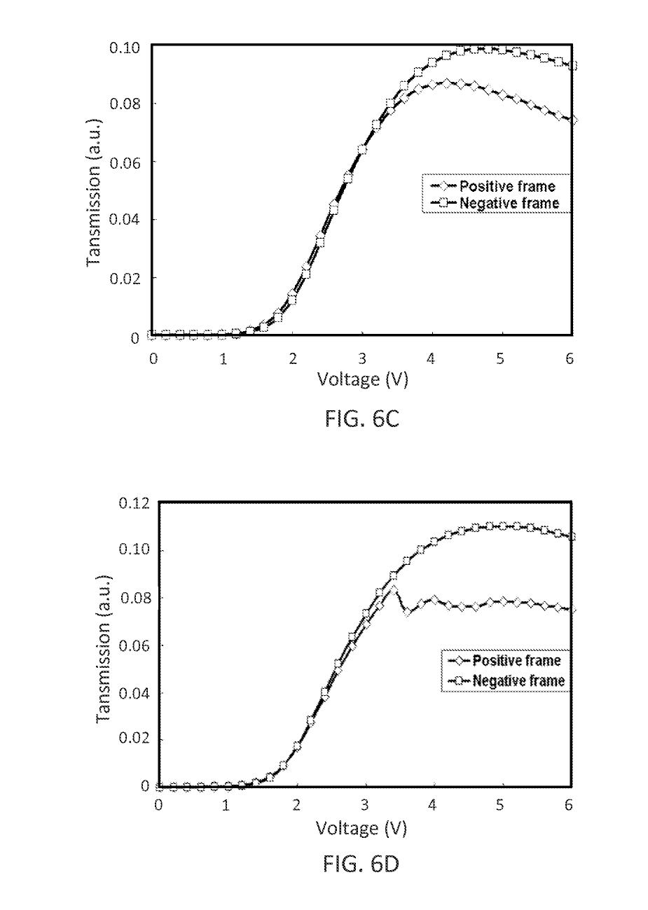

FIGS. 6A, 6B, 6C and 6D show schematically voltage-dependent transmittance (V-T) curves for the pixel structures 100 (FIG. 1A), 200 (FIG. 2A), 300 (FIG. 3A), 10 (FIG. 5), respectively. Table 2 lists a flexoelectric effect (FEE) ratio of the pixel structures 100 (FIG. 1A), 200 (FIG. 2A), 300 (FIG. 3A), 10 (FIG. 5). As shown in the FIG. 6D and Table 2, the pixel structure 10 is according to FIG. 5 in which the second electrode has three electrode strips 11, 12 and 13, and all the three electrode strips 11, 12 and 13 have the same strip width, the transmittance difference between the positive and negative frame V-T curves comes from the existence of the flexoelectric effect and the FEE ratio is 41%. As shown in the FIG. 6B and Table 2, the pixel structure 100 is according to the FIG. 1A, the transmittance difference between the positive and negative frame V-T curves is reduced and the FEE ratio is reduced to 13.48%. As shown in the FIG. 6C and Table 2, the pixel structure 200 is according to the FIG. 2A, the transmittance difference between the positive and negative frame V-T curves is reduced and the FEE ratio is reduced to 11.4%. As shown in the FIG. 6D and Table 2, the pixel structure 300 is according to the FIG. 3A, the transmittance difference between the positive and negative frame V-T curves is reduced and the FEE ratio is reduced to 11.08%. As disclosed above, the flexoelectric effect of the transmittance difference between the positive and negative frame V-T curves can be improved by adjusting the widths of the electrode strips.

TABLE 2
FEE Ratios of Different Embodiments

| | Strip width | |
|---|---|---|
| | (W1/W2) | FEE ratio |
| Prior art | 1.5/1.5 | 41% |
| Embodiment shown in FIG. 1A | 3/1.5 | 13.48% |
| Embodiment shown in FIG. 2A | 3/1.5 | 11.4% |
| Embodiment shown in FIG. 3A | 3/1.5 | 11.08% |

In another aspect of the present invention, a pixel structure comprises a first electrode; a dielectric layer formed on the first electrode; and a second electrode formed on the dielectric layer. The second electrodes comprises a plurality of first electrode strips and a plurality of second electrode strips, where the plurality of first electrode strips and the plurality of second electrode strips are spaced-apart and alternatively arranged along a first direction. Each first electrode strip has a width W1 and each second electrode strip has a width W2 along the first direction. The width W1 and the width W2 are different from each other.

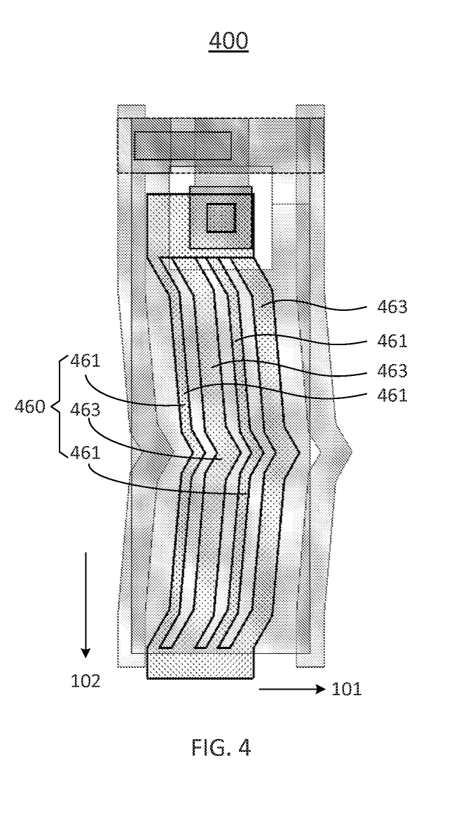

In one embodiment, the width W1 of each first electrode strip and the width W2 of each second electrode strip are constant along a second direction that is different from the first direction. As shown in FIG. 4, the second electrode 460 comprises two first electrode strips 461 and two second electrode strips 462 that are spaced-apart and alternatively arranged along the first direction 101. The width W1 of each first electrode strip 461 and the width W2 of each second electrode strip 462 are constant along the second direction 102. In this embodiment, W1<W2. In some embodiments, W1>W2. As disclosed above are not intended to limit the scope of the present invention. Designers can design the width W1 and the width W2 depending on their demands. Such corresponding changes are also within the scope of the present invention.

In another embodiment, the width W1 of each first electrode strip and the width W2 of each second electrode strip are variable along the second direction.

In one embodiment, each first electrode strip has a first portion with a first width W1a and a second portion with a second width W1b, extending from the first portion along the second direction, and each second electrode strip has a first portion with a first width W2a and a second portion with a second width W2b, extending from the first portion along the second direction. In one embodiment, W1a>W2a and W1b<W2b. In another embodiment, W1a<W2a and W1b>W2b.

In one embodiment, each first electrode strip has one or more first portions with a first width W1a and one or more second portions with a second width W1b, the one or more first portions and the one or more second portions being alternatively located along the second direction, and each second electrode strip has one or more first portions with a first width W2a and one or more second portions with a second width W2b, the one or more first portions and the one or more second portions being alternatively located along the second direction. In one embodiment, W1a>W2a and W1b<W2b. In another embodiment, W1a<W2a and W1b>W2b.

In one embodiment, one of the first and second electrodes is a pixel electrode, and the other of the first and second electrodes is a common electrode.

In one aspect, the present invention provides a liquid crystal display including a display panel having a plurality of pixels. Each pixel comprises the pixel structure as disclosed above. Accordingly, the FEE ratio is reduced significantly, resulting in the better liquid crystal efficiency or transmittance.

In sum, the invention, among other things, recites a pixel structure and a liquid crystal display utilizing the pixel structure. The pixel structure comprises a second electrode including one or more first electrode strips and one or more second electrode strip. The one or more first electrode strips and the one or more second electrode strips are spaced-apart and alternatively arranged along a first direction. Each first electrode strip has a width W1 and each second electrode strip has a width W2 along the first direction, where the width W1 and the width W2 are different from each other. In one embodiment, the first electrode strip width W1 and the second electrode strip width W2 are constant along the second direction. In another embodiment, the first electrode strip width W1 and the second electrode strip width W2 are variable along the second direction. Furthermore, the ratio of W1/W2 is in a range from about 0.2 to about 0.8, or in a range from about 2 to about 4. Accordingly, the FEE ratio of the pixel structure in the liquid crystal display is reduced, which leads to the better liquid crystal efficiency or transmittance.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A pixel structure, comprising:
a substrate;
a first electrode disposed on the substrate;
a first dielectric layer disposed on the first electrode; and
a second electrode disposed on the first dielectric layer,
wherein the second electrodes comprises a pair of first electrode strips and a second electrode strip disposed between the pair of first electrode strips, wherein each first electrode strips has a width W1, and the second electrode strip has a width W2 that is different from the width W1 along a first direction.

2. The pixel structure of claim 1, wherein the width W1 of each first electrode strip and the width W2 of the second electrode strip are constant along a second direction that is different from the first direction.

3. The pixel structure of claim 2, wherein a ratio of W1/W2 is in a range from about 0.2 to about 0.8, or in a range from about 2 to about 4.

4. The pixel structure of claim 1, wherein the width W1 of each first electrode strip and the width W2 of the second electrode strip are variable along a second direction that is different from the first direction.

5. The pixel structure of claim 4, wherein
each first electrode strip has a first portion with a first width W1a and a second portion with a second width W1b, extending from the first portion along the second direction; and
the second electrode strip has a first portion with a first width W2a and a second portion with a second width W2b, extending from the first portion along the second direction,
wherein W1a>W2a and W1b<W2b, or W1a<W2a and W1b>W2b.

6. The pixel structure of claim 5, wherein a ratio of W1a/W1b is in a range from about 0.2 to about 0.8, and a ratio of W2a/W2b is in a range from about 2 to about 4.

7. The pixel structure of claim 5, wherein a ratio of W1a/W1b is in a range from about 2 to about 4, and a ratio of W2a/W2b is in a range from about 0.2 to about 0.8.

8. The pixel structure of claim 5, wherein
each first electrode strip has one or more first portions with a first width W1a and one or more second portions with a second width W1b, the one or more first portions and the one or more second portions being alternatively located along the second direction; and
the second electrode strip has one or more first portions with a first width W2a and one or more second portions with a second width W2b, the one or more first portions and the one or more second portions being alternatively located along the second direction,
wherein W1a>W2a and W1b<W2b, or W1a<W2a and W1b>W2b.

9. The pixel structure of claim 8, wherein a ratio of W1a/W1b is in a range from about 0.2 to about 0.8, and a ratio of W2a/W2b is in a range from about 2 to about 4.

10. The pixel structure of claim 8, wherein a ratio of W1a/W1b is in a range from about 2 to about 4, and a ratio of W2a/W2b is in a range from about 0.2 to about 0.8.

11. The pixel structure of claim 1, wherein one of the first and second electrodes and is a pixel electrode, and the other of the first and second electrodes and is a common electrode.

12. The pixel structure of claim 1, further comprising a second dielectric layer 130 formed between the first electrode and the substrate.

13. The liquid crystal display, comprising a display panel having a plurality of pixels, each pixel comprising the pixel structure of claim 1.

14. A pixel structure, comprising:
a first electrode;
a dielectric layer formed on the first electrode; and
a second electrode formed on the dielectric layer,
wherein the second electrodes comprises one or more first electrode strips and one or more second electrode strips, wherein the one or more first electrode strips and the one or more second electrode strips are spaced-apart and alternatively arranged along a first direction, wherein each first electrode strip has a width W1 and each second electrode strip has a width W2 along the first direction, wherein the width W1 and the width W2 are different from each other.

15. The pixel structure of claim 14, wherein the width W1 of each first electrode strip and the width W2 of each second electrode strip are constant along a second direction that is different from the first direction

16. The pixel structure of claim 14, wherein the width W1 of each first electrode strip and the width W2 of each second electrode strip are variable along a second direction that is different from the first direction.

17. The pixel structure of claim 16, wherein
each first electrode strip has a first portion with a first width W1a and a second portion with a second width W1b, extending from the first portion along the second direction; and
each second electrode strip has a first portion with a first width W2a and a second portion with a second width W2b, extending from the first portion along the second direction,
wherein W1a>W2a and W1b<W2b, or W1a<W2a and W1b>W2b.

18. The pixel structure of claim 16, wherein
each first electrode strip has one or more first portions with a first width W1a and one or more second portions with a second width W1b, the one or more first portions and the one or more second portions being alternatively located along the second direction; and
each second electrode strip has one or more first portions with a first width W2a and one or more second portions with a second width W2b, the one or more first portions and the one or more second portions being alternatively located along the second direction,
wherein W1a>W2a and W1b<W2b, or W1a<W2a and W1b>W2b.

19. The pixel structure of claim 14, wherein one of the first and second electrodes and is a pixel electrode, and the other of the first and second electrodes and is a common electrode.

20. The liquid crystal display, comprising a display panel having a plurality of pixels, each pixel comprising the pixel structure of claim 14.
